(19) United States
(12) Patent Application Publication
(10) Pub. No.: US 2012/0057737 A1
(43) Pub. Date: Mar. 8, 2012

(54) Hybrid Acoustic/Electric Signal Converting Device

(75) Inventor: Gap Ryul Jung, Gyeonggi-do (KR)

(73) Assignee: PILKOR CST. CO., LTD., Gyeonggi-do (KR)

(21) Appl. No.: 13/259,890

(22) PCT Filed: May 20, 2011
(86) PCT No.: PCT/KR2011/003740

§ 371 Date: Nov. 7, 2011

(30) Foreign Application Priority Data
May 24, 2010 (KR) 10-2010-0047942

(51) Int. Cl. H04R 1/00

(52) U.S. Cl. 381/355

(57) ABSTRACT

This disclosure is directed to implementing a measure of additionally including and installing a load register connected to a circuit chip in a printed circuit board so that the corresponding circuit chip may normally obtain and receive a series of operation powers by using the load register included in the printed circuit board; and a measure of additionally installing a ground terminal, a signal output terminal and a power receiving terminal to a joining portion of a printed circuit board joined to the circuit board of the electronic device, and electrically connecting both of the signal output terminal and the power receiving terminal to the load register and the circuit chip in the printed circuit board so that the corresponding load register and the circuit chip may normally obtain the operation power supplied from the electronic device by indirectly using the output signal receiving terminal and the signal output terminal.

### TECHNICAL FIELD

This disclosure relates to a hybrid acoustic/electric signal converting device, and more particularly, to a hybrid acoustic/electric signal converting device for allowing a final product to perform stable hybrid operations at both a microphone circuit board (or, a circuit board without a power supply terminal) and a package circuit board (or, a circuit board without a load register) so that a producer (for example, an acoustic/electric signal converting microphone producer, an acoustic/electric signal converting package producer, an electric equipment producer, or the like) may greatly improve price competitiveness of its own product without any difficulty.

### BACKGROUND ART

Recently, as techniques relating to various electric/electronic devices such as information communication devices and acoustic devices are rapidly developing, the demand on acoustic/electric signal converting devices for converting acoustic signals into electric signals (for example, acoustic/electric signal converting microphones, acoustic/electric signal converting packages, or the like) is also rapidly increasing.

In general, an acoustic/electric signal converting device, for example an acoustic/electric signal converting microphone 10 includes a cylindrical case 1 having an acoustic inlet hole 1a, instruments received in the inner space of the case 1 and oscillating by the sound input through the acoustic inlet hole 1a, and a printed circuit board 2 having circuit chips 20 for electrically processing a capacitance variation caused by the corresponding instruments (for example, a FET chip) and noise reducing elements 21 for reducing external RF noise (for example, capacitor elements, inverter elements, resistance elements, and so on) in a state the above instruments are loaded on the printed circuit board 2 so that the case 1 and the printed circuit board 2 are systematically combined, as shown in FIG. 1.

An outer rim 1b of the case 1 is bent toward a receiving direction by a series of curling processes to firmly seal the instruments in the case 1 from the outside. The circuit chips 20 and the noise reducing elements 21 are electrically connected to each other by means of various kinds of electric connection means such as electric connection wires and electric connection patterns.

The instruments mentioned above may be, for example, a polar ring 3 and an oscillation plate 4 which configure an oscillation plate assembly 5, a dielectric plate 7 having a gap from the oscillation plate 4, a spacer ring 6 for forming a gap between the oscillation plate 4 and the dielectric plate 7, a conductive base ring 8 for electrically connecting the dielectric plate 7 and the printed circuit board 2, and an insulating base ring 9 for insulating the conductive base ring 8 and the dielectric plate 7 from the case 1.

The produced acoustic/electric signal converting microphone 10 is surface-mounted to a circuit board 90 included in an electronic device (various kinds of electric/electronic devices such as an information communication device, an acoustic device or the like) as shown in FIG. 2 to make an electric connection to the corresponding circuit board 90 so as to perform its own acoustic energy/electric energy converting role properly.

A ground terminal 2a for grounding the acoustic/electric signal converting microphone 10 and a signal output terminal 2b for outputting an electric signal of the acoustic/electric signal converting microphone 10 to the outside are additionally arranged on the rear surface of the printed circuit board 2 of the acoustic/electric signal converting microphone 10. In addition, a ground terminal 91 for grounding the acoustic/electric signal converting microphone 10 and an output signal receiving terminal 92 for receiving the electric signal output from the acoustic/electric signal converting microphone 10 are additionally arranged on the circuit board 90 of the electronic device, correspondingly.

In particular, the circuit board 90 of an electronic device that receives the acoustic/electric signal converting microphone 10 is additionally provided with a power supply module 93 for supplying power to the acoustic/electric signal converting microphone 10 and a separate component, for example a load register 94, for circuitry treatment of the supply power of the power supply module 93 (for example, processing the supply power to be suitable for the output voltage of the circuit chip 20). The supply power of the power supply module 93 which has passed through the load register 94 is supplied to the circuit chip 20 via the output signal receiving terminal 92 of the circuit board 90 and the signal output terminal 2b of the printed circuit board 2 of the acoustic/electric signal converting microphone 10.

Another general acoustic/electric signal converting device, for example an acoustic/electric signal converting package 70 includes a printed circuit board 40 on which an acoustic/electric signal converting element 16, a signal processing circuit set 30 and an electronic wave reducing element 50 (for example, a capacitor element, an inductor element, a resistance element, and so on) are loaded, and a cover container 60 placed on the printed circuit board 40 to cover the acoustic/electric signal converting element 16 and the signal processing circuit set 30, so that the printed circuit board 40 and the cover container 60 are closely combined, as shown in FIG. 3.

The acoustic/electric signal converting element 16 loaded on the printed circuit board 40 includes an oscillation plate 15 produced by means of Micro-ElectroMechanical System (MEMS), a back plate 12 covering the oscillation plate 15 and having/forming an acoustic hole 12a and an air gap 13, and a board 11 supporting the oscillation plate 15 and the back plate 12 and forming/defining a back chamber 14, so that those Components are organically combined. This configuration may be changed in various ways depending on conditions.

In a case where sound flows in through an acoustic inlet hole 61 formed in the cover container 61 and the sound flows through the acoustic hole 12a, the air gap 13 and further the back chamber 14, the acoustic/electric signal converting element 16 plays a role of converting and generating the corresponding sound into electric signals.

The signal processing circuit set 30 disposed near the acoustic/electric signal converting element 16 plays a role of supplying operation power to the acoustic/electric signal converting element 16 while forming a series of electric connections to the back plate 12 and the oscillation plate 15 of the acoustic/electric signal converting element 16 by means of various kinds of electric connection means such as electric connection wires and electric connection patterns. In addition, after processing the electric signals converted or generated by the acoustic/electric signal converting element 16, the signal processing circuit set 30 plays a role of outputting the processed electric signals to an electronic device (various kinds of electric/electronic devices such as information communication devices and acoustic devices).

The produced acoustic/electric signal converting package 70 is surface-mounted to the circuit board 80 included in an electronic device (various kinds of electric/electronic devices such as information communication devices and acoustic devices) as shown in FIG. 4 to form an electric connection with the corresponding circuit board 80 so as to perform its own acoustic energy/electric energy converting role properly.

A ground terminal 41 for grounding the acoustic/electric signal converting package 70, a signal output terminal 42 for outputting the electric signal of the acoustic/electric signal converting package 70 and a power receiving terminal 43 for receiving the power of an electronic device are additionally arranged on the rear surface of the printed circuit board 40 of the acoustic/electric signal converting package 70. In addition, a ground terminal 81 for grounding the acoustic/electric signal converting package 70, an output signal receiving terminal 82 for receiving the electric signal output from the acoustic/electric signal converting package 70 and a power supply terminal 83 for supplying power to the acoustic/electric signal converting package 70 are additionally provided to the circuit board 80 of the electronic device, correspondingly.

The cover container 60 is configured to firmly cover front, rear, right, left and upper surfaces of the printed circuit board 40 so that a series of chamber spaces S insulated from the outside is defined above the printed circuit board 40. By using this configuration, the cover container 60 guides the sound passing through the acoustic inlet hole 61 to be properly transmitted to the acoustic/electric signal converting element 16. In addition, even though a series of electronic waves is output from various devices while the acoustic/electric signal converting package 70 is mounted to an electronic device, the cove container 60 plays a role of a kind of Electro-Magnetic Interference (EMI) which protects the acoustic/electric signal converting element 16 and the signal processing circuit set 30 of the printed circuit board 40 not to badly influenced.

However, in the above general techniques, the acoustic/electric signal converting microphone 10 or the acoustic/electric signal converting package 70 strictly demands that surrounding circumstances should be precisely set suitably for inherent characteristics (for example, electric characteristics and design characteristics) in order to perform its own acoustic/electric signal converting function normally. Thus, if the circuit boards 80 and 90 satisfy the demands, a serious of acoustic/electric signal converting functions endowed thereto may be performed properly. However, if the circuit boards 80 and 90 do not satisfy the demands, it is impossible to properly perform the acoustic/electric signal converting functions endowed thereto, which is a fatal drawback. In other words, the general device may be restrictively installed and operated only on circuit boards 80 and 90 of any one electronic device.

For example, the general acoustic/electric signal converting microphone 10 demands the load register 94 as an essential component required for performing its operations normally. For this reason, the acoustic/electric signal converting microphone 10 may perform its own acoustic/electric signal converting function properly on a circuit board 90 having the corresponding load register 94 normally (in other words, on a circuit board for a microphone), but the acoustic/electric signal converting microphone 10 may not perform its own acoustic/electric signal converting function properly on a circuit board 80 not having the corresponding load register 94 normally (in other words, on a circuit board for a package). As a result, the acoustic/electric signal converting microphone 10 may be restrictively installed and operated only on the circuit board 90 of a specific electronic device (see FIGS. 2 and 4).

In addition, the acoustic/electric signal converting package 70 also demands the power supply terminal 83 for supplying power as an essential component required for performing its operations normally. For this reason, the acoustic/electric signal converting package 70 may perform its own acoustic/electric signal converting function normally on a circuit board 80 having the power supply terminal 83 properly (in other words, on a circuit board for a package), but the acoustic/electric signal converting package 70 my not perform the acoustic/electric signal converting function normally on a circuit board not having the power supply terminal 83 but having only the ground terminal 91 and the output signal receiving terminal 92 (in other words, on a circuit board for a microphone). As a result, the acoustic/electric signal converting package 70 may be restrictively installed and operated only on the circuit board 80 of a specific electronic device (see FIGS. 2 and 4).

If the acoustic/electric signal converting microphone 10 or the acoustic/electric signal converting package 70 is restrictively operated only on a circuit board of a specific electronic device just suitable for the same, a producer (for example, an acoustic/electric signal converting microphone producer, an acoustic/electric signal converting package producer, an electronic device producer, or the like) feels great difficulty in flexible management of products, which seriously deteriorates the price competitiveness of its products.

### DISCLOSURE

### Technical Problem

This disclosure is directed to flexibly implementing a measure of additionally including and installing a load register electrically connected to a circuit chip in a printed circuit board so that the corresponding circuit chip may normally obtain and receive a series of operation powers by using the load register included in the printed circuit board even in a circumstance where a load register is not installed to a circuit board of an electronic device; and a measure of additionally installing a ground terminal, a signal output terminal and a power receiving terminal to a joining portion of a printed circuit board joined to the circuit board of the electronic device and electrically connecting both of the signal output terminal and the power receiving terminal to the load register and the circuit chip in the printed circuit board so that the corresponding load register and the circuit chip may normally obtain the operation power supplied from the electronic device by indirectly using the output signal receiving terminal and the signal output terminal even in a circumstance where the circuit board of the electronic device has only the ground terminal and the output signal receiving terminal (in other words, in a circumstance where the power supply terminal is not provided). As a result, this disclosure is also directed to allowing a final product to perform stable hybrid operations on both a microphone circuit board (or, a circuit board not having a power supply terminal) and a package circuit board (or, a circuit board not having a load register) so that a producer (for example, an acoustic/electric signal converting microphone producer, an acoustic/electric signal converting package producer, an electronic device producer, or the like) may greatly improve the price competitiveness of its products without any difficulty.

Other objects of this disclosure will be more apparent from the following detailed description and the accompanying drawings.

### Technical Solution

In one general aspect, there is provided a hybrid acoustic/electric signal converting device, which includes: a cover container; instruments received and fixed in the cover container, the instruments oscillating by a sound flowing into the cover container; and a printed circuit board supporting the cover container and having a circuit chip for electrically processing a capacitance variation caused by the oscillation of the instruments, the printed circuit board being mounted in a circuit board of an electronic device, wherein a load register for operating the circuit chip is arranged in a part of the printed circuit board, wherein a ground terminal, a signal output terminal and a power receiving terminal electrically connected to the circuit board of the electronic device are arranged in another part of the printed circuit board, and wherein the load register is electrically connected to the signal output terminal and the power receiving terminal.

In another general aspect, there is provided a hybrid acoustic/electric signal converting device, which includes: a cylindrical case; instruments received in the case and oscillating by a sound flowing into the case; and a printed circuit board received in the case and having a circuit chip for electrically processing a capacitance variation caused by oscillation of the instruments, the printed circuit board being mounted to a circuit board of an electronic device, wherein a load register for operating the circuit chip is arranged in a part of the printed circuit board, wherein a ground terminal, a signal output terminal and a power receiving terminal electrically connected to the circuit board of the electronic device are arranged in another part of the printed circuit board, and wherein the load register is electrically connected to the signal output terminal and the power receiving terminal.

### Advantageous Effects

In this disclosure, a measure of additionally including and installing a load register electrically connected to a circuit chip in a printed circuit board so that the corresponding circuit chip may normally obtain and receive a series of operation powers by using the load register included in the printed circuit board even in a circumstance where a load register is not installed to a circuit board of an electronic device; and a measure of additionally installing a ground terminal, a signal output terminal and a power receiving terminal to a joining portion of a printed circuit board joined to the circuit board of the electronic device and electrically connecting both of the signal output terminal and the power receiving terminal to the load register and the circuit chip in the printed circuit board so that the corresponding load register and the circuit chip may normally obtain the operation power supplied from the electronic device by indirectly using the output signal receiving terminal and the signal output terminal even in a circumstance where the circuit board of the electronic device has only the ground terminal and the output signal receiving terminal (in other words, in a circumstance where the power supply terminal is not provided) are flexibly implemented. Therefore, a final product is allowed to perform stable hybrid operations on both a microphone circuit board (or, a circuit board not having a power supply terminal) and a package circuit board (or, a circuit board not having a load register) so that a producer (for example, an acoustic/electric signal converting microphone producer, an acoustic/electric signal converting package producer, an electronic device producer, or the like) may greatly improve the price competitiveness of its products without any difficulty.

### DESCRIPTION OF DRAWINGS

The above and other aspects, features and advantages of the disclosed exemplary embodiments will be more apparent from the following detailed description taken in conjunction with the accompanying drawings in which:

FIG. 1 shows an example of a general acoustic/electric signal converting microphone;

FIG. 2 is a conceptual view illustrating a process of mounting the general acoustic/electric signal converting microphone to a circuit board of an electronic device;

FIG. 3 shows an example of a general acoustic/electric signal converting package;

FIG. 4 is a conceptual view illustrating a process of mounting the general acoustic/electric signal converting package to a circuit board of an electronic device;

FIG. 5 is an exploded view showing a hybrid acoustic/electric signal converting device according to one embodiment disclosed herein;

FIG. 6 shows the hybrid acoustic/electric signal converting device of FIG. 5 in a reverse form;

FIGS. 7 and 8 are conceptual views showing a process of mounting the hybrid acoustic/electric signal converting device disclosed herein to a circuit board for a microphone and their circuitry connections;

FIGS. 9 and 10 are conceptual views showing a process of mounting the hybrid acoustic/electric signal converting device disclosed herein to a circuit board for a package and their circuitry connections;

FIG. 11 is an exploded view showing a hybrid acoustic/electric signal converting device according to another embodiment disclosed herein;

FIG. 12 shows the hybrid acoustic/electric signal converting device of FIG. 11 in a reverse form;

FIGS. 13 and 14 are conceptual views showing a process of mounting the hybrid acoustic/electric signal converting device according to another embodiment disclosed herein to a circuit board for a microphone and their circuitry connections; and

FIGS. 15 and 16 are conceptual views showing a process of mounting the hybrid acoustic/electric signal converting device according to another embodiment disclosed herein to a circuit board for a package and their circuitry connections.

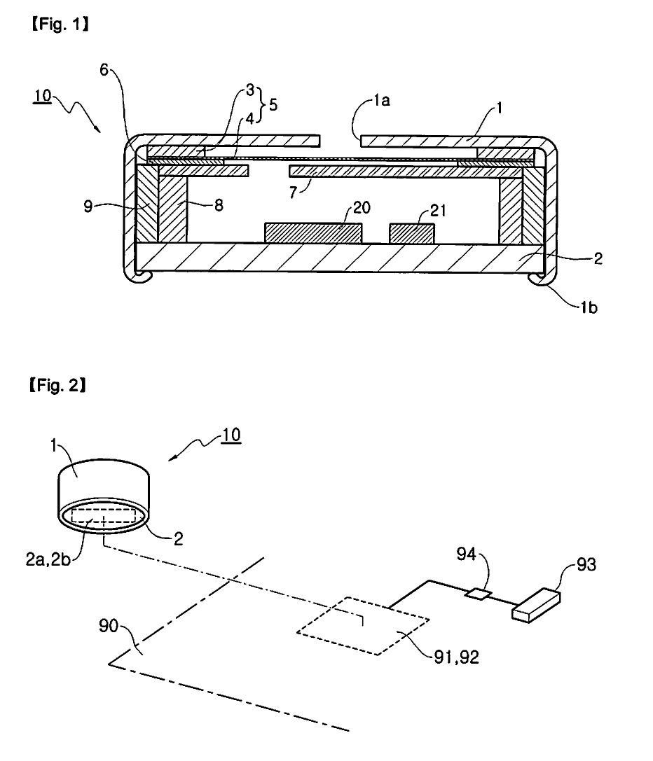

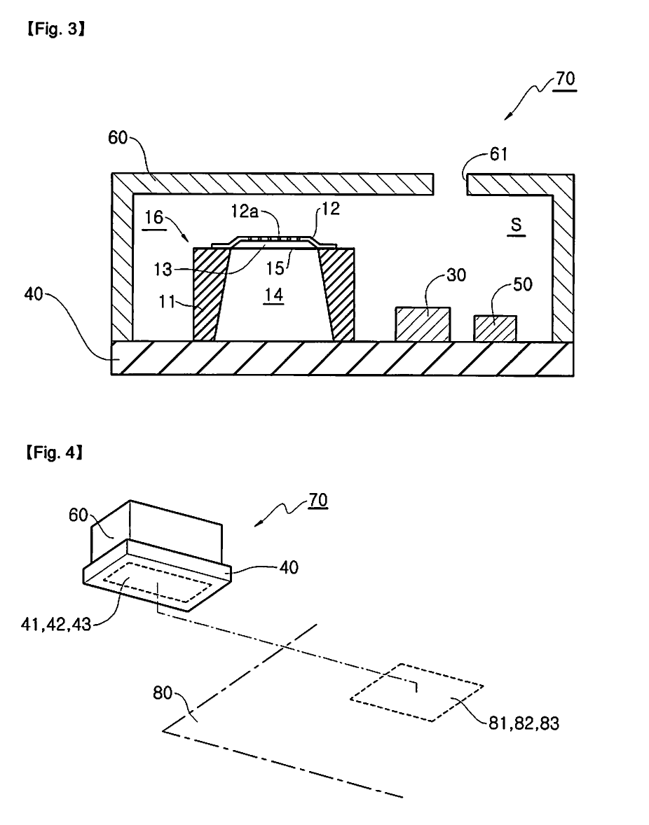

### MODE FOR INVENTION

Hereinafter, a hybrid acoustic/electric signal converting device disclosed herein will be described in detail with reference to the accompanying drawings.

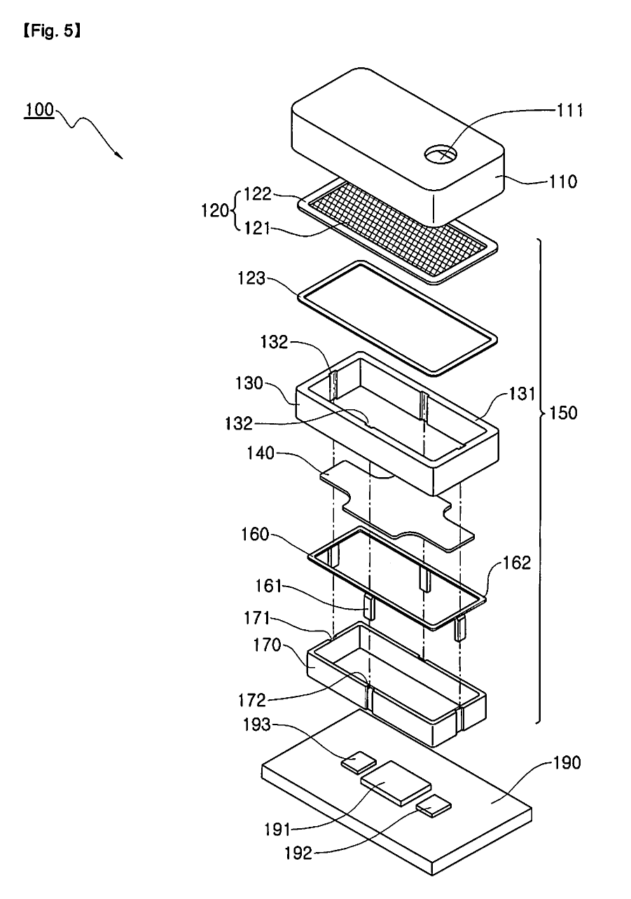

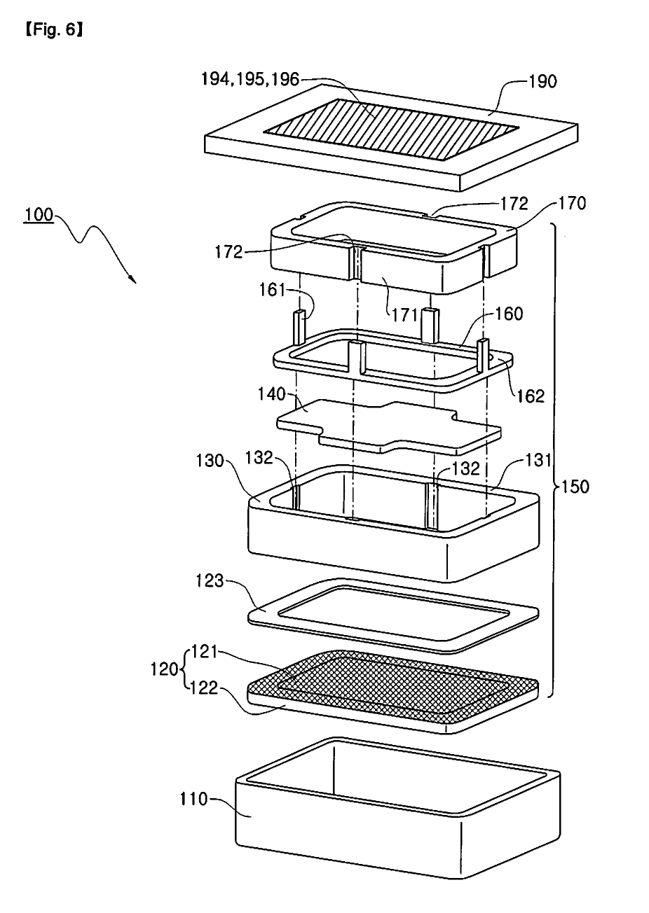

As shown in FIGS. 5 and 6, a hybrid acoustic/electric signal converting device according to one embodiment disclosed herein, for example a package-type hybrid acoustic/electric signal converting device 100 includes an angled (or, rectangular) cover container 110 having a sound inlet hole 111, instruments 150 received in an inner space of the cover container 110 and oscillating by a sound input through the sound inlet hole 111, and a printed circuit board 190 supporting the cover container 110 and having a circuit chip 191 for electrically processing a capacitance variation caused by oscillation of the instruments 150 (for example, a FET chip) and a noise reducing element 192 for reducing an external RF noise (for example, a capacitor element, an inductor element, a resistance element, or the like). The cover container 110, the instruments 150 and the printed circuit board 190 are systematically combined.

The circuit chip 191 and the noise reducing element 192 are electrically connected to each other by means of various kinds of connection means such as electric connection wires and electric connection patterns.

The instruments 150 may include an oscillation plate assembly 120, a spacer plate 123, an insulating/compressing base block 130, a dielectric plate 140, a conductive contact block 160, an insulating/compressing auxiliary block 170 and so on, which are placed on the cover container 110 in order as shown in FIG. 6. The kinds and arrangements of these instruments 150 may be flexibly changed depending on circumstances.

The oscillation plate assembly 120 includes a fixing plate 122 and an oscillation plate 121. The dielectric plate 140 may be made of any material depending on circumstances, for example polymer material or Si material.

The cover container 110 is made of, for example, aluminum (Al) or copper (Cu). The fixing plate 122 is made of, for example, Ni-plated brass plate. The spacer plate 123 is made of, for example, polyethyleneterephthalate (PET) film or polyimide (PI) film. The oscillation plate 121 is made of gold- or nickel-coated PET film or gold- or nickel-coated polyphenylene sulfide (PPS) film. It would be obvious that the materials and shapes of the components may be changed depending on circumstances.

In the above configuration, the produced acoustic/electric signal converting device 100 is surface-mounted to circuit boards 80 and 90 included in an electronic device (various kinds of electric/electronic devices such as information communication devices and acoustic devices) as shown in FIGS. 7 and 9 to make an electric connection with the corresponding circuit boards 90 and 80 in order to perform its own acoustic energy/electric energy converting role.

The circuit board of the electronic device, for example, the circuit board 90 for a microphone further includes a ground terminal 91 for grounding the acoustic/electric signal converting device 100, an output signal receiving terminal 92 for receiving the electric signal output from the acoustic/electric signal converting device 100, a power supply module 93 for supplying power to the acoustic/electric signal converting device 100, and so on (see FIG. 7). In addition, a circuit board of another kind of electronic device, for example the circuit board 80 for a package further includes a ground terminal 81 for grounding the acoustic/electric signal converting device 100, an output signal receiving terminal 82 for receiving the electric signal output from the acoustic/electric signal converting device 100, a power supply terminal 83 for supplying power to the acoustic/electric signal converting device 100, and so on (see FIG. 9).

In this circumstance, a producer (for example an acoustic/electric signal converting microphone producer, an acoustic/electric signal converting package producer, an electronic device producer, or the like) feels the necessity on that the final product 100 can operate stably on both of the circuit board 90 for a microphone (or, a circuit board not having a power supply terminal) (see FIG. 7) and the circuit board 80 for a package (or, a circuit board not having a load register) (see FIG. 9).

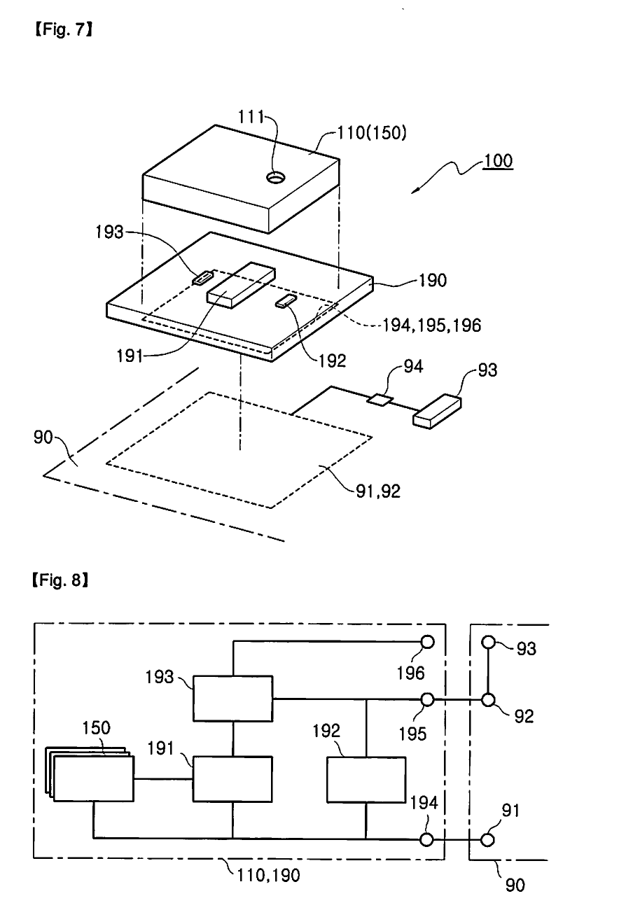

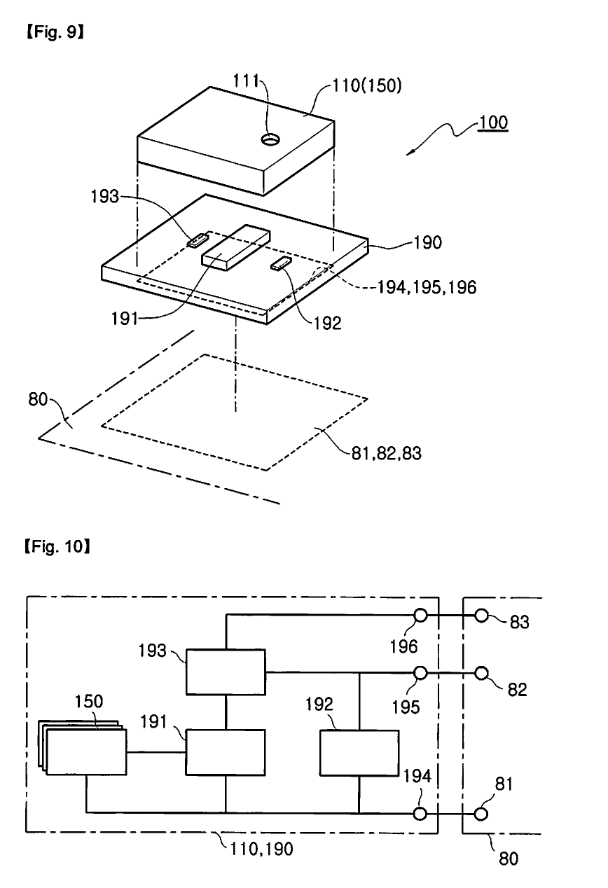

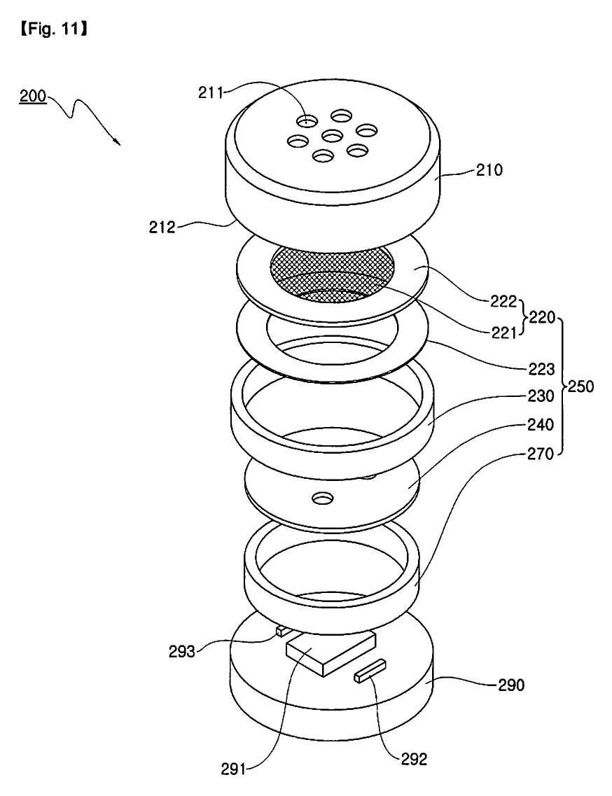

In this disclosure, there may be flexibly taken a measure of additionally including and installing a load register 193 electrically connected to the circuit chip 191 to process the supply power for operating the circuit chip 191 (for example, to control the supply power suitably for the output voltage of the circuit chip 191) by a circuit, to a part (for example, the inner surface) of the printed circuit board 190 (in this case, the load register 193 may be imbedded in the printed circuit board 190); and a measure of additionally installing a ground terminal 194 for grounding the acoustic/electric signal converting device 100, a signal output terminal 195 for outputting the electric signal of the acoustic/electric signal converting device 100 to the outside, and a power receiving terminal 196 for receiving the power of the electronic device, to another part (for example, the surface contacting the circuit board) of the printed circuit board 190, as shown in FIGS. 7 and 9; as well as a measure of electrically connecting both of the signal output terminal 195 and the power receiving terminal 196 to the load register 193 of the printed circuit board 190, as shown in FIGS. 8 and 10.

In a case where the hybrid acoustic/electric signal converting device 100 disclosed herein is loaded to the circuit board 90 for a microphone (in other words, a circuit board not having a power supply terminal) as shown in FIG. 7 in a state that the above measures are taken, the hybrid acoustic/electric signal converting device 100 may electrically connect the ground terminal 194 to the ground terminal 91 of the circuit board 90 and also electrically connect the signal output terminal 195 electrically connected to the load register 193 to the output signal receiving terminal 92 of the circuit board 90 in a stable way, instead of the power receiving terminal 196, as shown in FIG. 8. As a result, the hybrid acoustic/electric signal converting device 100 disclosed herein may properly obtain the operation power supplied from the electronic device by indirectly using the output signal receiving terminal 92 and the signal output terminal 195 even though the circuit board 90 of the electronic device has only the ground terminal 91 and the output signal receiving terminal 92 (in other words, even though a power supply terminal is not provided separately).

In addition, in a case where the hybrid acoustic/electric signal converting device 100 disclosed herein is loaded to the circuit board 80 for a package (in other words, a circuit board not having a load register) as shown in FIG. 9 in a state that the above measures are taken, the hybrid acoustic/electric signal converting device 100 may utilize the load register 193 included therein to normally obtain and control a series of operation powers output from the power supply terminal 83 while electrically connecting the ground terminal 194, the signal output terminal 195 and the power receiving terminal 196 to the ground terminal 81, the output signal receiving terminal 82 and the power supply terminal 83 of the circuit board, as shown in FIG. 10. As a result, the hybrid acoustic/electric signal converting device 100 disclosed herein may normally perform a series of acoustic/electric signal converting functions without any difficulty even though a load register is not installed to the circuit board 80 of the electronic device.

As described above, this disclosure flexibly implements a measure for additionally including and installing the load register 193 electrically connected to the circuit chip 191 in the printed circuit board 190 and then guiding the corresponding circuit chip 191 to use the load register 193 in the printed circuit board 190 to normally obtain and control a series of operation powers even though a load register is not installed to the circuit board 80 of the electronic device; and a measure for additionally installing the ground terminal 194, the signal output terminal 195 and the power receiving terminal 196 to a joining portion of the printed circuit board 190 joined to the circuit boards 80 and 90 of the electronic device, and electrically connecting both of the signal output terminal 195 and the power receiving terminal 196 to the load register 193 and the circuit chip 191 in the printed circuit board 190 so that the corresponding load register 193 and the circuit chip 191 may normally obtain the operation power supplied from the electronic device by indirectly using the output signal receiving terminal 92 and the signal output terminal 195 even though the circuit board 90 of the electronic device has only the ground terminal 91 and the output signal receiving terminal 92 (in other words, even though a power supply terminal is not provided separately). For this reason, if this disclosure is implemented, the final product 100 may take stable hybrid-type operations at both of the circuit board 90 for a microphone (or, a circuit board not having a power supply terminal) and the circuit board 80 for a package (or, a circuit board not having a load register). As a result, a producer (for example, an acoustic/electric signal converting microphone producer, an acoustic/electric signal converting package producer, an electronic device producer, or the like) may greatly improve the price competitiveness of its products without any difficulty.

Meanwhile, as shown in FIGS. 7 and 9, the package-type hybrid acoustic/electric signal converting device 100 according to one embodiment disclosed herein is configured so that the cover container 110 having a smaller size than the printed circuit board 190 is placed on and joined and arranged to the printed circuit board 190. For this reason, a producer may not easily curl the outer rim of the cover container 110. This difficulty will be sublimated into an advantage due to the inherent structure disclosed herein.

As shown in FIGS. 5 and 6, it is devised in this disclosure to additionally arrange the insulating/compressing base block 130 and the insulating/compressing auxiliary block 170 in the cover container 110.

When the instruments 150 are coupled, the insulating/compressing base block 130 is closely received in the cover container 110 while compressing and surrounding the oscillation plate 121 and the fixing plate 122 as well as the outer periphery of the dielectric plate 140 to play a role of fixing the oscillation plate 121 and the fixing plate 122 as well as the dielectric plate 140 in the cover container 110 and a role of electrically insulating the oscillation plate 121 and the fixing plate 122 as well as the dielectric plate 140 from the cover container 110.

In addition, in a state where the insulating/compressing base block 130 is closely received in the cover container 110, the insulating/compressing auxiliary block 170 is closely received in the insulating/compressing base block 130 to play a role of supporting the oscillation plate 121 and the fixing plate 122 as well as the dielectric plate 140 surrounded by the insulating/compressing base block 130 to be pressed and fixed into the cover container 110.

As a result, due to the roles of the insulating/compressing base block 130 and the insulating/compressing auxiliary block 170, the package-type hybrid acoustic/electric signal converting device 100 according to one embodiment disclosed herein may stably fix the instruments 150 in the cover container 110 without curling the cover container 110.

As mentioned above, the package-type hybrid acoustic/electric signal converting device 100 according to one embodiment disclosed herein may easily avoid the process of curling the cover container 110 by using the insulating/compressing base block 130 and the insulating/compressing auxiliary block 170. For this reason, when this disclosure is implemented, a producer may not only enjoy the advantages of the hybrid-type device 100 as described above but also easily avoid various problems caused by curling of the cover container 110, for example the destruction of a gap balance of the instructments 150 caused by curling stress, the destruction of a balance of a back chamber (or, a sound-passing space formed above the printed circuit board 190), the deformation/damage caused by the stress originating from the curling process of the dielectric plate 140, the leakage of sound caused by each balance destruction/curling miss, and so on.

As shown in FIGS. 5 and 6, a conductive contact block 160 having a rectangular ring-shaped body 162 and a pin 161 integrally connected to the body 162 and protruding to a predetermined height is additionally arranged between the insulating/compressing auxiliary block 170 and the insulating/compressing base block 130. The shape and number of the pin 161 may be changed variously depending on circumstances.

When the instruments 150 are coupled, the pin 161 and the body 162 of the conductive contact block 160 respectively contact the dielectric plate 140 and the printed circuit board 190 in a state where the pin 161 is inserted into the outer wall of the body 171 of the insulating/compressing auxiliary block 170 and the inner wall of the body 131 of the insulating/compressing base block 130, so that the corresponding dielectric plate 140 and the printed circuit board 190 are electrically connected.

A first pin guide groove 172 is additionally formed in the outer wall of body 171 of the insulating/compressing auxiliary block 170 so that the pin 161 of the conductive contact block 160 is inserted therein, and a second pin guide groove 132 is additionally formed in the inner wall of the body 131 of the insulating/compressing base block 130 so that the pin 161 of the conductive contact block 160 is inserted therein (see FIGS. 5 and 6).

While the conductive contact block 160 plays its role, the gap between the oscillation plate 121 and the dielectric plate 140 varies according to an external sound passing through the sound inlet hole 111 of the cover container 110. For reference, the gap is formed by the spacer plate 123. If the gap varies, a series of current signals is modified, and the corresponding current signal modification may be rapidly transmitted to the circuit chip 191 of the printed circuit board 190 by means of the conductive contact block 160. As a result, even though the insulating/compressing auxiliary block 170 is additionally arranged between the dielectric plate 140 and the printed circuit board 190, the acoustic/electric signal converting device 100 may normally play its own acoustic/electric signal converting role without any difficulty.

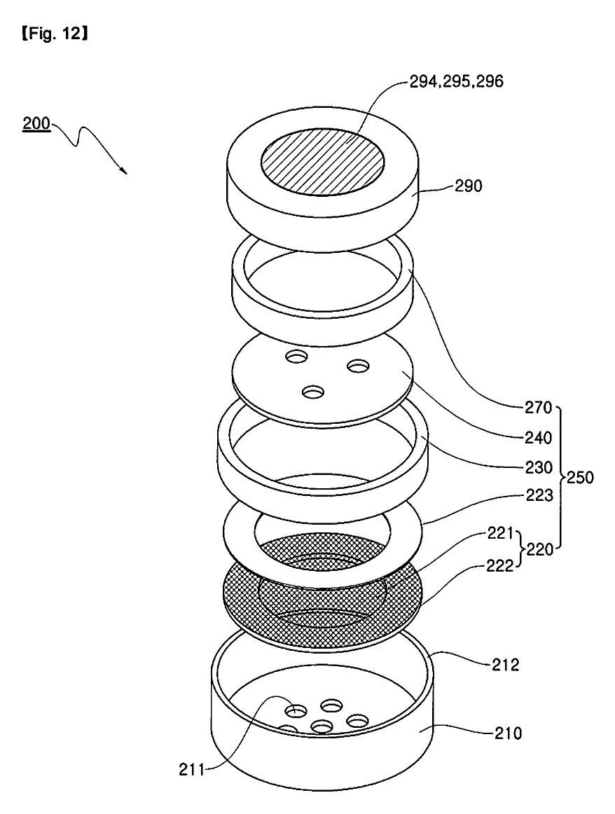

Meanwhile, as shown in FIGS. 11 and 12, a hybrid acoustic/electric signal converting device according to another embodiment disclosed herein, for example a microphone-type hybrid acoustic/electric signal converting device 200 includes a cylindrical case 210 having a sound inlet hole 211, instruments 250 received in the inner space of the case 210 and oscillating by the sound flowing in through the sound inlet hole 211, and a printed circuit board 290 received in the inner space of the case 210 and having a circuit chip 291 (for example, a FET chip) for electrically processing a capacitance variation caused by oscillation of the instruments 250 and a noise reducing element 292 (for example, a capacitor element, an inductor element, a resistance element, or the like) for reducing an external RF noise. The case 210, the instruments 250 and the printed circuit board 290 are systematically combined.

An outer rim 212 of the case 210 is curled toward the receiving space by a series of curling processes so that the instruments 250 in the case 210 are firmly sealed from the outside. The circuit chip 291 and the noise reducing element 292 are electrically connected with each other by means of various kinds of electric connection means such as electric connection wires and electric connection patterns.

The instruments 250 may include an oscillation plate assembly 220, a spacer ring 223, an insulating base ring 230, a dielectric plate 240, a conductive base ring 270 and so on, which are placed on the case 210 and loaded in the receiving space of the case 210 in order as shown in FIG. 12. The kinds and arrangements of these instruments 250 may be flexibly changed depending on circumstances. The oscillation plate assembly 220 includes a polar ring 222 and an oscillation plate 221. The dielectric plate 240 may be made of polymer material or Si material depending on circumstances.

The case 210 is made of, for example, aluminum (Al) or copper (Cu). The polar ring 222 is made of, for example, Ni-plated brass plate. The spacer ring 223 is made of, for example, PET film or PI film. The oscillation plate 221 is made of gold- or nickel-coated PET film or gold- or nickel-coated PPS film.

It would be obvious that the materials and shapes of the components may be changed depending on circumstances.

In a state where the instruments 250 are coupled, the conductive base ring 270 electrically connects the dielectric plate 240 and the printed circuit board 290. For this reason, if a current signal modification is generated due to the change of a gap between the oscillation plate 221 of the oscillation plate assembly 220 and the dielectric plate 240, the conductive base ring 270 guides the corresponding current signal modification to be transmitted to the circuit chip 291 of the printed circuit board 290.

In addition, the insulating base ring 230 covers the rims of the conductive base ring 270 and the dielectric plate 240 in a state where the instruments 250 are coupled, so as to play a role of preventing the corresponding conductive base ring 270 and the dielectric plate 240 from electrically contacting the inner wall of the case 210. In this case, the insulating base ring 230 may be replaced with an insulating film formed on the inner wall of the case 210 depending on circumstances.

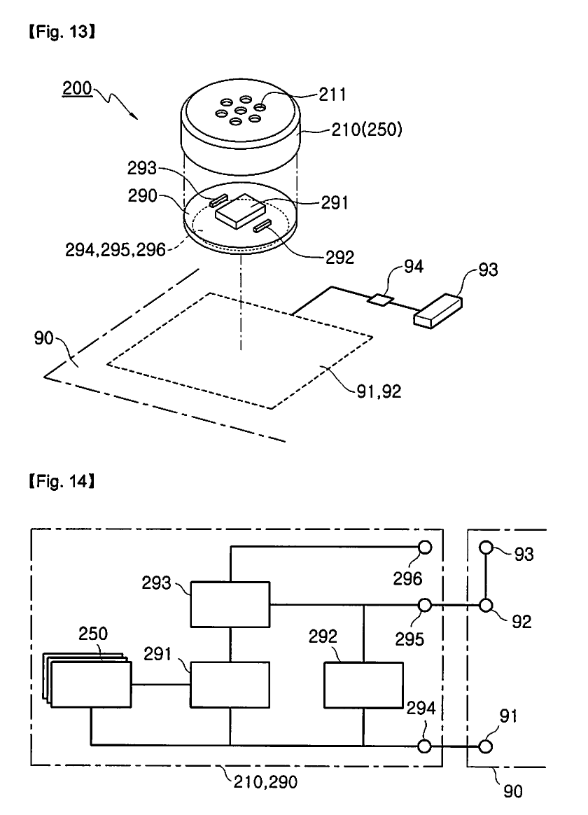

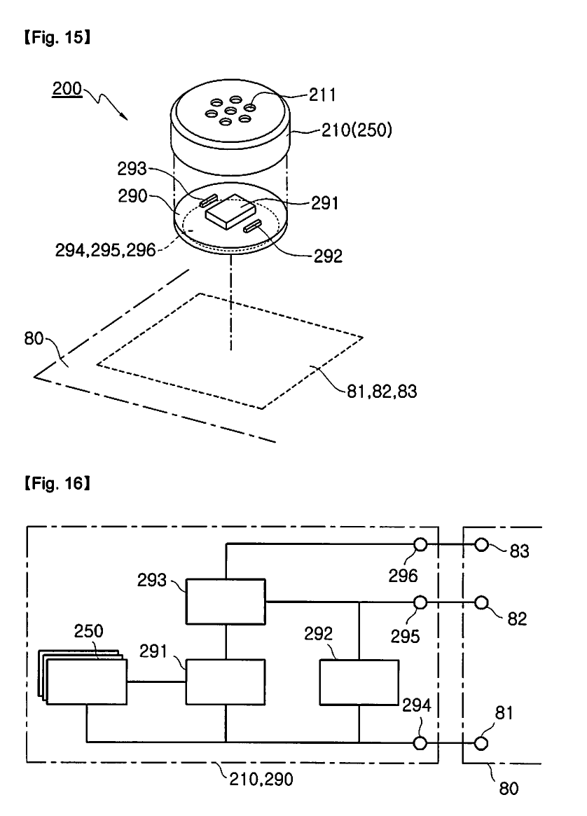

In this configuration disclosed herein, the produced acoustic/electric signal converting device 200 is surface-mounted to circuit boards 80 and 90 included in an electronic device (various kinds of electric/electronic devices such as information communication devices and acoustic devices) as shown in FIGS. 13 and 15 to make an electric connection with the corresponding circuit boards 90 and 80 in order to perform its own acoustic energy/electric energy converting role properly.

Even in this case, the circuit board of the electronic device, for example, the circuit board 90 for a microphone further includes a ground terminal 91 for grounding the acoustic/electric signal converting device 200, an output signal receiving terminal 92 for receiving the electric signal output from the acoustic/electric signal converting device 200, a power supply module 93 for supplying power to the acoustic/electric signal converting device 200, and so on (see FIG. 13). In addition, a circuit board of another kind of electronic device, for example the circuit board 80 for a package further includes a ground terminal 81 for grounding the acoustic/electric signal converting device 200, an output signal receiving terminal 82 for receiving the electric signal output from the acoustic/electric signal converting device 200, a power supply terminal 83 for supplying power to the acoustic/electric signal converting device 200, and so on (see FIG. 15).

In this circumstance, a producer (for example an acoustic/electric signal converting microphone producer, an acoustic/electric signal converting package producer, an electronic device producer, or the like) feels the necessity on that the final product 200 can operate stably on both of the circuit board 90 for a microphone (or, a circuit board not having a power supply terminal) (see FIG. 13) and the circuit board 80 for a package (or, a circuit board not having a load register) (see FIG. 15).

In this disclosure, there may be flexibly taken a measure of additionally including and installing a load register 293 electrically connected to the circuit chip 291 to process the supply power for operating the circuit chip 291 (for example, to control the supply power suitably for the output voltage of the circuit chip 291) by a circuit, to a part (for example, the inner surface) of the printed circuit board 290 (in this case, the load register 293 may be imbedded in the printed circuit board 290); and a measure of additionally installing a ground terminal 294 for grounding the acoustic/electric signal converting device 200, a signal output terminal 295 for outputting the electric signal of the acoustic/electric signal converting device 200 to the outside, and a power receiving terminal 296 for receiving the power of the electronic device, to another part (for example, the surface contacting the circuit board) of the printed circuit board 290, as shown in FIGS. 13 and 15; as well as a measure of electrically connecting both of the signal output terminal 295 and the power receiving terminal 296 to the load register 293 of the printed circuit board 290, as shown in FIGS. 14 and 16.

In a case where the hybrid acoustic/electric signal converting device 200 according to another embodiment disclosed herein is loaded to the circuit board 90 for a microphone (in other words, a circuit board not having a power supply terminal) as shown in FIG. 13 in a state that the above measures are taken, the hybrid acoustic/electric signal converting device 200 may electrically connect the ground terminal 294 to the ground terminal 91 of the circuit board and also electrically connect the signal output terminal 295 electrically connected to the load register 293 to the output signal receiving terminal 92 of the circuit board 90 in a stable way, instead of the power receiving terminal 296, as shown in FIG. 14. As a result, the hybrid acoustic/electric signal converting device 200 disclosed herein may properly obtain the operation power supplied from the electronic device by indirectly using the output signal receiving terminal 92 and the signal output terminal 295 even though the circuit board 90 of the electronic device has only the ground terminal 91 and the output signal receiving terminal 92 (in other words, even though a power supply terminal is not provided separately).

In addition, in a case where the hybrid acoustic/electric signal converting device 200 disclosed herein is loaded to the circuit board 80 for a package (in other words, a circuit board not having a load register) as shown in FIG. 15 in a state that the above measures are taken, the hybrid acoustic/electric signal converting device 200 may utilize the load register 293 included therein to normally obtain and control a series of operation powers output from the power supply terminal 83 while electrically connecting the ground terminal 294, the signal output terminal 295 and the power receiving terminal 296 to the ground terminal 81, the output signal receiving terminal 82 and the power supply terminal 83 of the circuit board, as shown in FIG. 16. As a result, the hybrid acoustic/electric signal converting device 200 according to another embodiment disclosed herein may normally perform a series of acoustic/electric signal converting functions without any difficulty even though a load register is not installed to the circuit board 80 of the electronic device.

As described above, this disclosure flexibly implements a measure for additionally including and installing the load register 293 electrically connected to the circuit chip 291 in the printed circuit board 290 and then guiding the corresponding circuit chip 291 to normally obtain and control a series of operation powers by using the load register 293 in the printed circuit board 290 even though a load register is not installed to the circuit board 80 of the electronic device; and a measure for additionally installing the ground terminal 294, the signal output terminal 295 and the power receiving terminal 296 to a joining portion of the printed circuit board 290 joined to the circuit boards 80 and 90 of the electronic device, and electrically connecting both of the signal output terminal 295 and the power receiving terminal 296 to the load register 293 and the circuit chip 291 in the printed circuit board 290 so that the corresponding load register 293 and the circuit chip 291 may normally obtain the operation power supplied from the electronic device by indirectly using the output signal receiving terminal 92 and the signal output terminal 295 even though the circuit board 90 of the electronic device has only the ground terminal 91 and the output signal receiving terminal 92 (in other words, even though a power supply terminal is not provided separately). For this reason, if this disclosure is implemented, the final product 200 may take stable hybrid-type operations at both of the circuit board 90 for a microphone (or, a circuit board not having a power supply terminal) and the circuit board 80 for a package (or, a circuit board not having a load register). As a result, a producer (for example, an acoustic/electric signal converting microphone producer, an acoustic/electric signal converting package producer, an electronic device producer, or the like) may greatly improve the price competitiveness of its products without any difficulty.

The above disclosure is useful for various kinds of electronic/electric devices that require an acoustic/electric signal converting device.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A hybrid acoustic/electric signal converting device, comprising:
a cover container;
instruments received and fixed in the cover container, the instruments oscillating by a sound flowing into the cover container; and
a printed circuit board supporting the cover container and having a circuit chip for electrically processing a capacitance variation caused by the oscillation of the instruments, the printed circuit board being mounted in a circuit board of an electronic device,
wherein a load register for operating the circuit chip is arranged in a part of the printed circuit board,
a ground terminal, a signal output terminal and a power receiving terminal electrically connected to the circuit board of the electronic device are arranged in another part of the printed circuit board, and
the load register is electrically connected to the signal output terminal and the power receiving terminal.

2. The hybrid acoustic/electric signal converting device according to claim 1, wherein the instruments include:
an oscillation plate received in the cover container and oscillating by a sonic wave input through the cover container;
a fixing plate for fixing the oscillating plate;
a dielectric plate supporting the fixing plate while keeping a gap from the oscillation plate;
an insulating/compressing base block closely received in the cover container while compressing and surrounding the oscillation plate and the fixing plate as well as the outsides of the dielectric plate so as to fix the oscillation plate, the fixing plate and the dielectric plate in the cover container, the base block electrically insulating the oscillation plate, the fixing plate and the dielectric plate from the cover container; and
an insulating/compressing auxiliary block closely received in the insulating/compressing base block while the insulating/compressing base block is closely received in the cover container so as to press and fix the oscillation plate, the fixing plate and the dielectric plate into the cover container,
wherein a conductive contact block having a body and a pin is further arranged between the insulating/compressing auxiliary block and the insulating/compressing base block so that the pin is inserted into an outer wall of the insulating/compressing auxiliary block and an inner wall of the insulating/compressing base block to electrically connect the dielectric plate and the printed circuit board.

3. The hybrid acoustic/electric signal converting device according to claim 2, wherein a first pin guide groove is further formed in the outer wall of the insulating/compressing auxiliary block in order to guide the insertion of the pin to the conductive contact block.

4. The hybrid acoustic/electric signal converting device according to claim 2, wherein a second pin guide groove is further formed in the inner wall of the insulating/compressing base block in order to guide the insertion of the pin to the conductive contact block.

5. A hybrid acoustic/electric signal converting device, comprising:
a cylindrical case;
instruments received in the case and oscillating by a sound flowing into the case; and
a printed circuit board received in the case and having a circuit chip for electrically processing a capacitance variation caused by oscillation of the instruments, the printed circuit board being mounted to a circuit board of an electronic device,
wherein a load register for operating the circuit chip is arranged in a part of the printed circuit board,
a ground terminal, a signal output terminal and a power receiving terminal electrically connected to the circuit board of the electronic device are arranged in another part of the printed circuit board, and
the load register is electrically connected to the signal output terminal and the power receiving terminal.
